(19) United States
(12) Patent Application Publication
(10) Pub. No.: US 2004/0051693 A1
(43) Pub. Date: Mar. 18, 2004

(54) Electronic screen having display panel displayed in changeable length-width ratio

(76) Inventor: Ming-Jian Chen, Shindian City (TW)

Correspondence Address: TROJAN LAW OFFICES, 9250 WILSHIRE BLVD, SUITE 325, BEVERLY HILLS, CA, 90212

(21) Appl. No.: 10/242,657

(22) Filed: Sep. 12, 2002

(51) Int. Cl. G09G 5/00

(52) U.S. Cl. 345/156

(57) ABSTRACT

An electronic screen is provided. The electronic screen includes a screen casing having a display panel displayed in a first length-width ratio, and a covering device mounted on two symmetrical sides of the screen casing and movable towards the center of the screen casing for covering a portion thereof so as to show the display panel in a second length-width ratio.

### FIELD OF THE INVENTION

This invention relates to a screen covering device, and more particularly to a screen covering device enabling the screen to be displayed in different length-width ratios.

### BACKGROUND OF THE INVENTION

In the twenty-first century, many products have been digitalized. The television is no exception. Compared to a traditional TV, the digital TV offers higher quality in both video and audio. That is because the digital TV processes, compresses, and encodes the audio and video signals separately and then transmits them by means of a digital modulation.

The video signal currently broadcasted by television stations is in accordance with the NTSC (National Television Standards Committee) standard which only offers the definition of 200,000 pixels on a screen having a length-width ratio of 4:3. However, the digital TV can offer the definition of 2,000,000 pixels on a wide-format screen which has a length-width ration of 16:9. Thus, in comparing the digital TV with the traditional TV, not only are the pixel DPI (Dot Per Inch) of the digital TV ten times greater than the traditional one, but the width of the digital TV screen is increased by thirty percent, thus having the effect of a movie screen. Consequently, through the digital TV, the general appearance of the picture will be more beautiful and clear, the viewer's eyes will feel more comfortable, and also the viewer will experience greater vividness in sound and picture.

However, because presently the image standard transmitted by the general television station is still mainly in the ratio of 4:3, when the 4:3 image standard is displayed on the 16:9 wide-format screen, black portions show on two sides. Because of this situation, the quality and efficiency of the vision of the digital TV is lessened.

Because of the technical defects described above, the applicant continually pursues, unflaggingly, to develop through wholehearted experience and research an “electronic screen having display panel displayed in changeable length-width ratio”.

### SUMMARY OF THE INVENTION

It is an object of the present invention to provide an electronic screen having a display panel which can be displayed in a changeable length-width ratio.

It is another object of the present invention to provide a TV screen whose display panel can be displayed in a length-width ratio which may be changed between 4:3 and 16:9.

In accordance with an aspect of the present invention, an electronic screen includes a screen casing having a display panel displayed in a first length-width ratio, and a covering device mounted on two symmetrical sides of the screen casing and movable towards the center of the screen casing for covering a portion thereof so as to show the display panel in a second length-width ratio.

Preferably, the electronic screen is a TV screen.

Certainly, the TV screen can be a digital TV screen.

Preferably, the first length-width ratio is 16:9.

Certainly, the second length-width ratio can be 4:3.

Preferably, the first length-width ratio is 4:3.

Certainly, the second length-width ratio can be 16:9.

Preferably, the two symmetrical sid es of the screen case are left and right sides.

Preferably, the two symmetrical sides of the screen case are upper and lower sides.

Preferably, the covering device is an audio displaying device.

Certainly, the audio displaying device can be a speaker.

In accordance with another aspect of the present invention, a covering device mounted on two symmetrical sides of a display panel displayed in a first length-width ratio is provided. The covering device is movable towards the center of the display panel for covering a portion thereof so as to show the display panel in a second length/width ratio.

Preferably, the display panel is a TV screen.

Certainly, the TV screen can be a digital TV screen.

Preferably, the first length-width ratio is 16:9.

Certainly, the second length-width ratio can be 4:3.

Preferably, the first length-width ratio is 4:3.

Certainly, the second length-width ratio can be 16:9.

Preferably, the two symmetrical sides of the electronic screen are left and right sides.

Preferably, the two symmetrical sides of the electronic screen are upper and lower sides.

Preferably, the covering device is an audio displaying device.

Certainly, the audio displaying device can be a speaker.

In accordance with another further aspect of the present invention, an electronic screen includes a screen casing having a display panel displayed in a first length-width ratio, a first covering device mounted on two symmetrical sides of the screen casing and movable towards the center of the screen casing for covering a portion thereof so as to show the display panel in a second length-width ratio, and a second covering device mounted on the other two symmetrical sides of the screen casing and movable towards the center of the screen casing for covering a portion thereof so as to show the display panel in a third length-width ratio.

The above objects and advantages of the present invention will become more readily apparent to those ordinarily skilled in the art after reviewing the following detailed descriptions and accompanying drawings, in which:

### BRIEF DESCRIPTION OF THE DRAWINGS

FIG. 1A shows a schematic view of the electronic screen having a display panel displayed in a changeable length-width ratio in one preferable embodiment according to the present invention;

FIG. 1B shows a schematic view of the electronic screen having a display panel displayed in an altered length-width ratio in one preferable embodiment according to the present invention;

FIG. 2A shows a schematic view of the electronic screen having a display panel displayed in a changeable length-width ratio in another preferable embodiment according to the present invention;

FIG. 2B shows a schematic view of the electronic screen having a display panel displayed in an altered length-width ratio in another preferable embodiment according to the present invention; and

FIG. 3 shows a schematic view of the electronic screen having a display panel displayed in a changeable length-width ratio in the other preferable embodiment according to the present invention.

### DETAILED DESCRIPTION OF THE PREFERRED EMBODIMENT

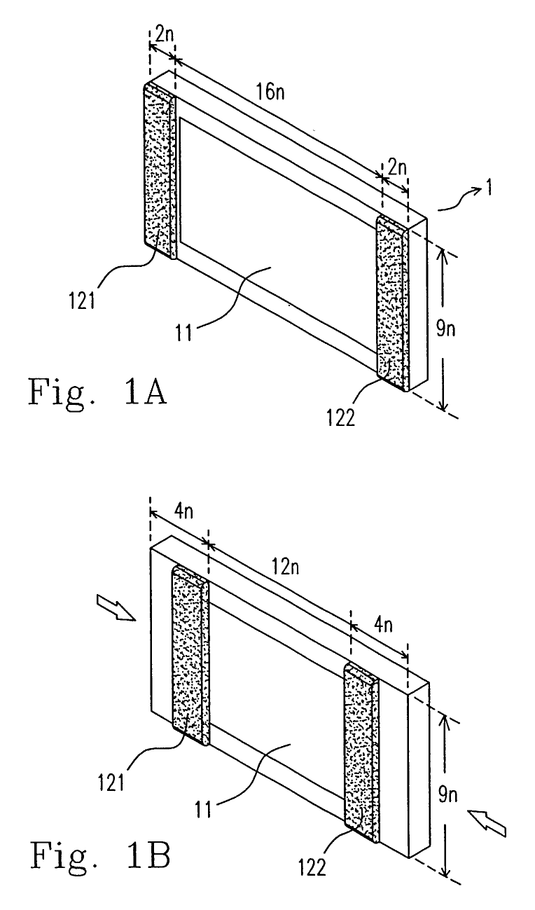

Please refer to FIG. 1A. FIG. 1A illustrates a schematic view of the electronic screen having a display panel displayed in a changeable length-width ratio in one preferred embodiment according to the present invention. In this preferred embodiment, the electronic screen is a TV screen. The TV screen includes a screen casing 1 having the display panel 11 displayed in a length-width ratio of 16:9, and a covering device 121, 122. The covering device 121, 122 is mounted on the left and right sides of the screen casing 1 and can be removed toward the center of the display panel 11 for covering a portion thereof. If the length and width of the display panel 11 are supposed as 16 n and 9 n units (n=1, 2, 3, . . . ), and the width of the covering device is supposed as 2 n units, the display panel 11 will be displayed in a length-width ratio of 4:3 when the covering device 121, 122 is moved completely towards the center thereof (as shown in FIG. 1B).

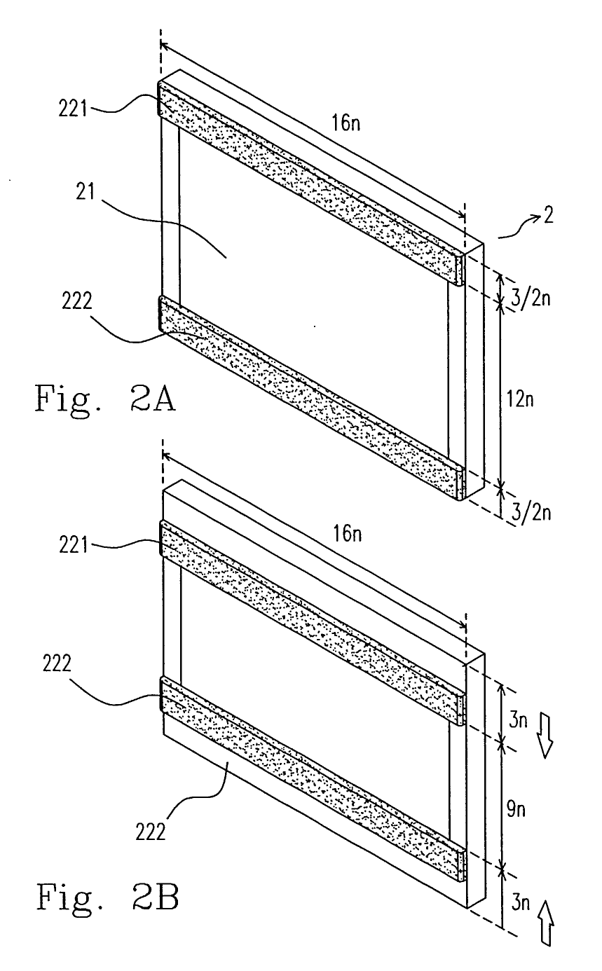

Another preferred embodiment of the present invention is illustrated in FIG. 2A. FIG. 2A illustrates a schematic view of the electronic screen having a display panel displayed in a changeable length-width ratio according to the present invention. In this preferred embodiment, the electronic screen is a TV screen. The TV screen includes a screen casing 2 having the display panel 21 displayed in a length-width ratio of 4:3, and a covering device 221, 222.

The covering device 221, 222 is mounted on the upper and lower sides of the screen casing 2 and can be removed toward the center of the display panel 21 for covering a portion thereof. If the length and width of the display panel 11 are supposed as 16 n and 12 n units (n=1, 2, 3, . . . ), and the width of the covering device is supposed as (3/2)n units, the display panel 21 will be displayed in a length-width ratio of 16:9 when the covering device 221, 222 is moved completely towards the center (as shown in FIG. 2B).

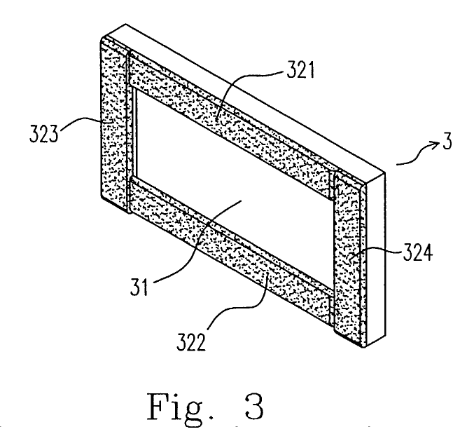

Furthermore, please refer to FIG. 3 which illustrates a schematic view of the electronic screen having a display panel displayed in a changeable length-width ratio in the other preferable embodiment according to the present invention. In this preferred embodiment, the electronic screen is a TV screen. The TV screen includes a screen casing 3 having the display panel 31, and a covering device 321, 322, 323, and 324. As shown in FIG. 3, the screen casing 3 can be mounted by the covering device 321, 322, 323, and 324 around the four sides, so that the viewer can have more choices to match his desires when viewing.

According to the present invention, it is preferable for the covering device to be designed as a sound broadcasting device, such as a speaker. It is also foreseeable that other electronic peripherals may serve as the covering device. Moreover, through this diversified design, the present invention can efficiently reduce the space that is occupied by the peripheral products while still altering the length-width ratio of the display panel. Thus, the electronic screen according to the present invention has numerous variations and multiple efficiencies.

In view of the aforementioned, the electronic screen having a display panel displayed in a changeable length-width ratio of the present invention relies on the covering device to change the length-width ratio of display panel of the electronic screen according to the viewer's desires. Consequently, the present invention conforms to the demand of the industry and owns inventiveness.

While the invention has been described in terms of what is presently considered to be the most practical and preferred embodiments, it is to be understood that the invention needs not be limited to the disclosed embodiment. To the contrary, it is intended to cover various modifications and similar arrangements included within the spirit and scope of the appended claims which are to be accorded the broadest interpretation so as to encompass all such modifications and similar structures.

What is claimed is:

1. An electronic screen, comprising:
a screen casing having a display panel displayed in a first length-width ratio; and
a covering device mounted on two symmetrical sides of said screen casing and movable towards the center of said screen casing for covering a portion thereof so as to show said display panel in a second length-width ratio.

2. An electronic screen according to claim 1 wherein said electronic screen is a TV screen.

3. An electronic screen according to claim 2 wherein said TV screen is a digital TV screen.

4. An electronic screen according to claim 1 wherein said first length-width ratio is 16:9.

5. An electronic screen according to claim 4 wherein said second length-width ratio is 4:3.

6. An electronic screen according to claim 1 wherein said first length-width ratio is 4:3.

7. An electronic screen according to claim 6 wherein said second length-width ratio is 16:9.

8. An electronic screen according to claim 1 wherein said two symmetrical sides of said screen case are left and right sides.

9. An electronic screen according to claim 1 wherein said two symmetrical sides of said screen case are upper and lower sides.

10. An electronic screen according to claim 1 wherein said covering device is an audio displaying device.

11. An electronic screen according to claim 10 wherein said audio displaying device is a speaker.

12. A covering device mounted on two symmetrical sides of a display panel displayed in a first length-width ratio, wherein said covering device is movable towards the center of said display panel for covering a portion thereof so as to show said display panel in a second length/width ratio.

13. A device according to claim 12 wherein said display panel is a TV screen.

14. A device according to claim 13 wherein said TV screen is a digital TV screen.

15. A device according to claim 1 wherein said first length-width ratio is 16:9.

16. A device according to claim 15 wherein said second length-width ratio is 4:3.

17. A device according to claim 12 wherein said first length-width ratio is 4:3.

18. A device according to claim 17 wherein said second length-width ratio is 16:9.

19. A device according to claim 12 wherein said two symmetrical sides of said electronic screen are left and right sides.

20. A device according to claim 12 wherein said two symmetrical sides of said electronic screen are upper and lower sides.

21. A device according to claim 12 wherein said covering device is an audio displaying device.

22. A device according to claim 21 wherein said audio displaying device is a speaker.

23. An electronic screen, comprising:
a screen casing having a display panel displayed in a first length-width ratio;
a first covering device mounted on primary two symmetrical sides of said screen casing and movable towards the center of said screen casing for covering a portion thereof so as to show said display panel in a second length-width ratio; and
a second covering device mounted on secondary two symmetrical sides of said screen casing and movable towards the center of said screen casing for covering a portion thereof so as to show said display panel in a third length-width ratio.
